(19) United States
(12) Patent Application Publication
(10) Pub. No.: US 2026/0364967 A1
(43) Pub. Date: Nov. 19, 2026

(54) PRINTING METHOD AND ROBOT SYSTEM

(71) Applicant: SEIKO EPSON CORPORATION, Tokyo (JP)

(72) Inventors: Kaori SATO, FUJIMI-MACHI (JP); Keigo SUGAI, CHINO-SHI (JP)

(21) Appl. No.: 19/209,675

(22) Filed: May 15, 2025

(51) Int. Cl. B41M 5/00; B25J 11/00; B41J 3/407; B41J 11/00; B41M 3/00

(52) U.S. Cl. CPC B41M 5/0088; B25J 11/0075; B41J 3/4073; B41J 11/008; B41M 3/008

(57) ABSTRACT

A printing method using an ink ejection head and a robot to perform printing while the robot arm scans the ink ejection head, the printing method including steps of performing a first printing by ejecting ink from a first nozzle array in a state in which the relative position of a distal end of the robot arm with respect to a proximal end of the robot arm is at a predetermined position, moving the ink ejection head relative to a target object such that a second nozzle array is disposed at the same position as the first nozzle array during the first printing and a relative position of the distal end of the robot arm is at the predetermined position, and performing a second printing while the robot arm scans the ink ejection head relative to the object along the same scan trajectory as during the first printing.

### BACKGROUND OF THE INVENTION

### 1. Technical Field

The present disclosure relates to a printing method and a robot system.

### 2. Related Art

There is known a three dimensional object printing device that by combining operations of a plurality of movable sections, moves an ink jet print head and performs printing on the surface of a three dimensional object.

For example, JP-2013-20278 discloses a system for printing on three dimensional target objects, including a joint-arm robot, a print head, a piezoactuator arranged between them, and a detector for detecting the position of the printing point. The robot is configured to move the print head along the surface of the target object. By this, it is possible to perform printing in multiple passes including printing trajectories adjacent to each other. JP-2013-20278 discloses that piezo-actuators provide relative motion of the print head with respect to the robot. JP-2013-20278 discloses that, using this system, when printing is performed in multiple passes while moving the print head along two adjacent print trajectories, the actual positions of the print points of the first print trajectory are detected, the deviation between the target positions and the actual positions is calculated, and a compensation motion is performed in the second print trajectory to eliminate the deviation. By this, deviation between printing passes is suppressed, and an error-free image can be printed.

On the other hand, vibration is generated in the robot along with the operation. This vibration causes the ink jet print head to oscillate for a predetermined cycle. For this reason, for example, even in a case where ink is discharged while the ink jet print head is linearly scanned with respect to the printing target object, the printed image is accompanied by the undulation of a predetermined distance cycle. However, since the undulation causes the entire head to wobble, local deterioration in image quality is small. Therefore, the image may be used while allowing the undulation of the image or correcting the undulation using another means.

However, in a case where the ink jet print head has a plurality of nozzle arrays, the above-described undulation causes local deterioration in image quality. For example, when inks of different colors are discharged from two nozzle arrays, the inks are discharged from different nozzle arrays for each color. The nozzle arrays are arranged at positions separated from each other in the head.

Therefore, the positional relationship between the nozzle array and the robot is different for each color. In this case, when the nozzle array is moved to a target position with respect to the printing target object, the posture of the robot varies for each color. As a result, a phenomenon occurs in which the phase of the undulation differs for each color. This phenomenon causes the landing position of the ink to deviate from the original position. As a result, print defects are generated such as misalignment of dots, color unevenness, and color shift.

It is an issue to provide a printing method in which print defects can be suppressed to a low level even when an inkjet print head having a plurality of nozzle arrays performs a printing operation with oscillation.

### SUMMARY OF THE INVENTION

A printing method according to the application example of the disclosure uses an ink ejection head including a first nozzle array and a second nozzle array, the first nozzle array and the second nozzle array each including a plurality of nozzles for ejecting ink and a robot including a robot arm that causes the ink ejection head to scan in a scanning direction with respect to a target object, assuming that a direction in which the first nozzle array and the second nozzle array are arranged is the scanning direction and a linear stage that causes the ink ejection head to relatively move with respect to the target object, the printing method being for printing on the target object by ejecting ink from the ink ejection head while the robot arm causes the ink ejection head to scan, the printing method including a first printing step of, in a state where a relative position of a distal end of the robot arm with respect to a proximal end of the robot arm is at a predetermined position, performing a first printing on the target object by ejecting ink from the first nozzle array while the robot arm causes the ink ejection head to scan relative to the target object; a head position adjustment step of, after the first printing step, causing the linear stage to move the ink ejection head relative to the target object such that the second nozzle array is arranged at the same position as the first nozzle array at the time of the first printing and so that the relative position of the distal end of the robot arm becomes the predetermined position; and a second printing step of, after the head position adjustment step, performing a second printing on the target object by ejecting ink from the second nozzle array while the robot arm relatively scans the ink ejection head with respect to the target object along the same scan trajectory as in the first printing.

A robotic system according to an application example of the present disclosure includes an ink ejection head including a first nozzle array and a second nozzle array, the first nozzle array and the second nozzle array each including a plurality of nozzles for ejecting ink, a robot including a robot arm that causes the ink ejection head to scan in a scanning direction with respect to a target object, assuming that a direction in which the first nozzle array and the second nozzle array are arranged is the scanning direction and a linear stage that causes the ink ejection head to relatively move with respect to the target object, and a control device that controls an operation of the robot, wherein the control device executes a first printing operation of, from a state where a relative position of a distal end of the robot arm with respect to a proximal end of the robot arm is at a predetermined position, causing the robot arm to perform a first printing with respect to a target position of the target object by causing ink to be ejected from the first nozzle array while causing the ink ejection head to scan relatively to a target position of the target object; a head position adjustment operation of, after the first printing operation, causing the linear stage to move the ejection head relative to target object so as to arrange the second nozzle array at the same position as the first nozzle array at the time of the first printing and so that the relative position of the distal end of the robot arm becomes the predetermined position; and a second printing operation of, after the head position adjustment operation, performing a second printing on the target position of the target object by causing ink to be ejected from the second nozzle array while causing the robot arm to scan the ink ejection head relative to the target object along the same scan trajectory as in the first printing.

### BRIEF DESCRIPTION OF DRAWINGS

FIG. 1 is a perspective view illustrating overall configuration of a printing device (robot system) according to the first embodiment.

FIG. 2 is a functional block diagram of the printing device shown in FIG. 1.

FIG. 3 is a plan view showing a linear stage and a liquid ejection head (ink ejection head) shown in FIG. 1.

FIG. 4 is a partially enlarged view of the liquid ejection head shown in FIG. 3.

FIG. 5 is a side view schematically showing a part of a printing device as a related art technique for explaining an issue to be solved by the printing method according to the first embodiment.

FIG. 6 is a plan view showing an example of a printing pattern formed by using the printing device shown in FIG. 5.

FIG. 7 is a plan view showing the arrangement of nozzles of a liquid ejection head used to form the print pattern shown in FIG. 6.

FIG. 8 is a diagram schematically showing position of the liquid ejection head and position of a robot arm at the moments when dots dYB, dYA, dCB, and dCA are sequentially formed in first to fourth scans with respect to the target position of the target object in the process of forming the print pattern shown in FIG. 6.

FIG. 9 is a side view schematically showing a part of the printing device shown in FIG. 1.

FIG. 10 is a plan view showing an example of a print pattern created by using the printing device shown in FIG. 9.

FIG. 11 is a flowchart for explaining the printing method according to the first embodiment.

FIG. 12 is a diagram schematically showing position of the liquid ejection head and position of a robot arm at the moments when dots dYB, dYA, dCB, and dCA are sequentially formed in first to fourth scans with respect to the target position of the target object in the process of forming the printing pattern shown in FIG. 10.

FIG. 13 is a side view schematically showing a part of a printing device used in the printing method according to the second embodiment.

FIG. 14 is a side view schematically showing a part of a printing device used in the printing method according to the second embodiment.

### DETAILED DESCRIPTION OF THE INVENTION

Hereinafter, suitable embodiments of a printing method and a robot system according to the disclosure will be described in detail with reference to the accompanying drawings.

### 1. FIRST EMBODIMENT

First, a printing method and a robot system according to a first embodiment will be described.

### 1.1. Printing device

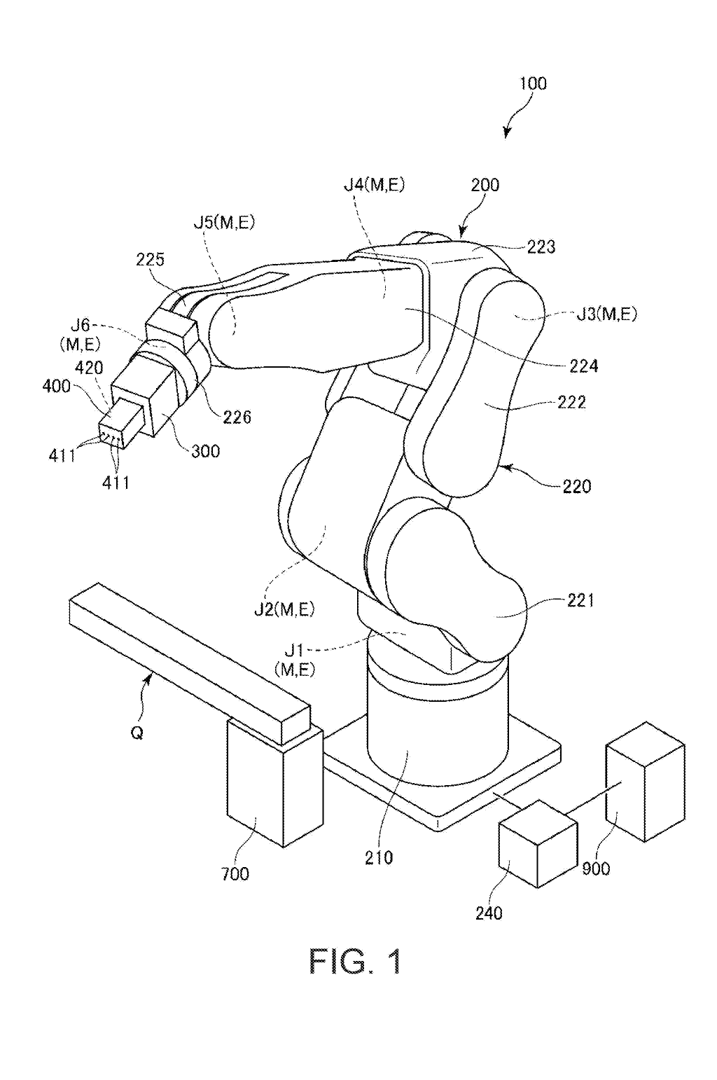

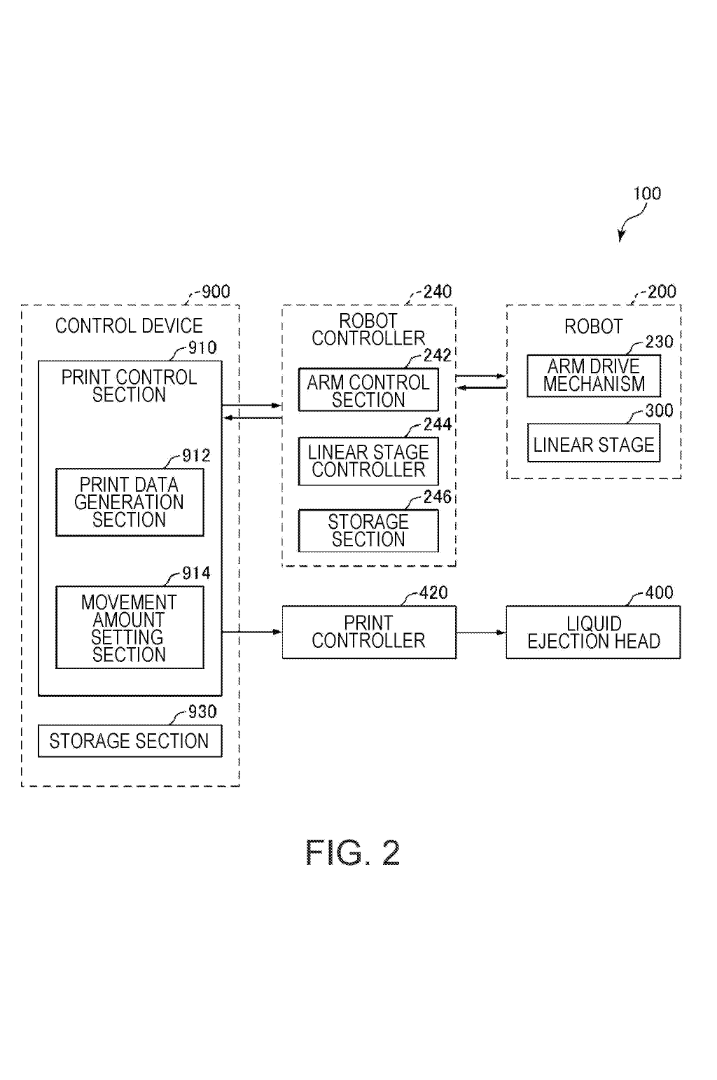

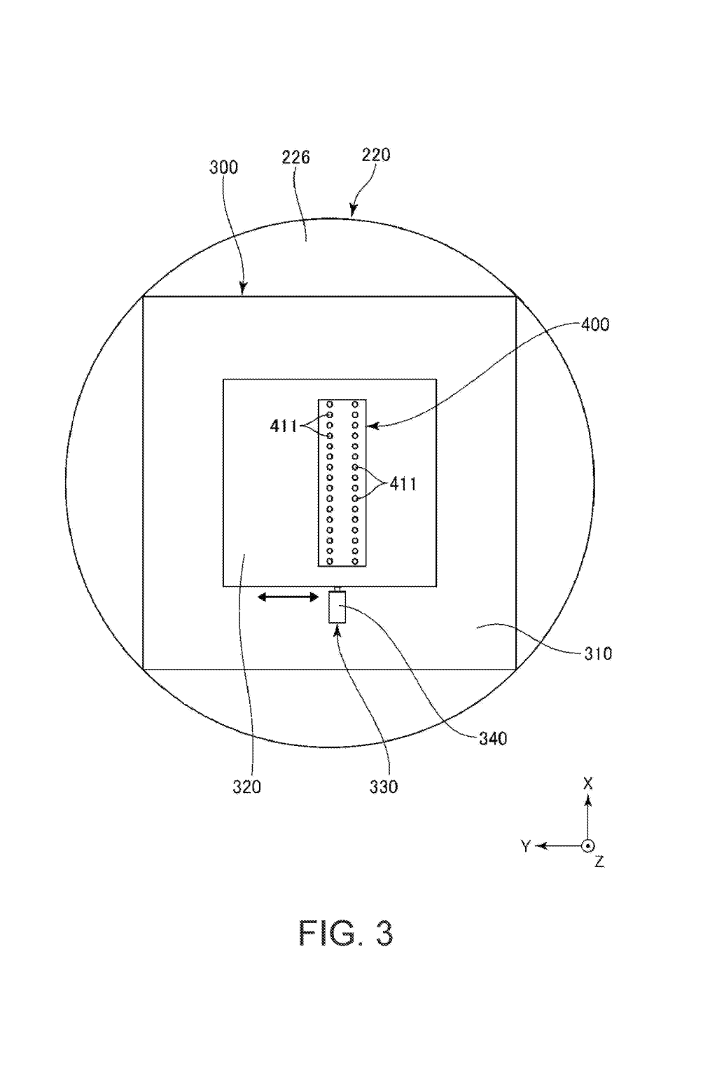

FIG. 1 is a perspective view illustrating an overall configuration of a printing device (robot system) 100 according to the first embodiment. FIG. 2 is a functional block diagram of the printing device 100 shown in FIG. 1. FIG. 3 is a plan view showing a linear stage 300 and a liquid ejection head (ink ejection head) 400 shown in FIG. 1.

The printing device 100 illustrated in FIG. 1 includes a robot 200, a liquid ejection head 400, a fixing member 700 that supports and fixes a target object Q, and a control device 900.

The robot 200 is a six axis vertical articulated robot having six drive axes. The robot 200 includes a base 210 fixed to a floor, a robot arm 220 connected to the base 210, and a linear stage 300 attached to the robot arm 220. Note that the number of drive axes included in the robot 200 may be less than or more than six. The robot 200 may be a horizontal articulated robot or a multi-arm robot having a plurality of robot arms.

The robot arm 220 is a robotic arm with a plurality of arms 221, 222, 223, 224, 225, and 226 that are rotatably connected, and that has six joints J1 through J6. Among them, the joints J2, J3, and J5 are bending joints, and the joints J1, J4, and J6 are torsional joints. The robot arm 220 is provided with an arm drive mechanism 230 shown in FIG. 2. The arm drive mechanism 230 is configured from motors M and encoders E provided in the joints J1, J2, J3, J4, J5, and J6 illustrated in FIG. 1. The motors M are drive sources that drive the joints J1, J2, J3, J4, J5, and J6. The encoders E detect rotation amount of the motors M (rotation angle of the arm).

As shown in FIG. 3, the liquid ejection head 400 is attached to the distal end of the arm 226 via a linear stage 300. The liquid ejection head 400 shown in FIG. 3 includes an ink chamber (not shown), a vibration plate disposed on a wall surface of the ink chamber, and a plurality of nozzles 411 connected to the ink chamber, and is configured such that the ink in the ink chamber is ejected from the nozzles 411 by vibration of the vibration plate.

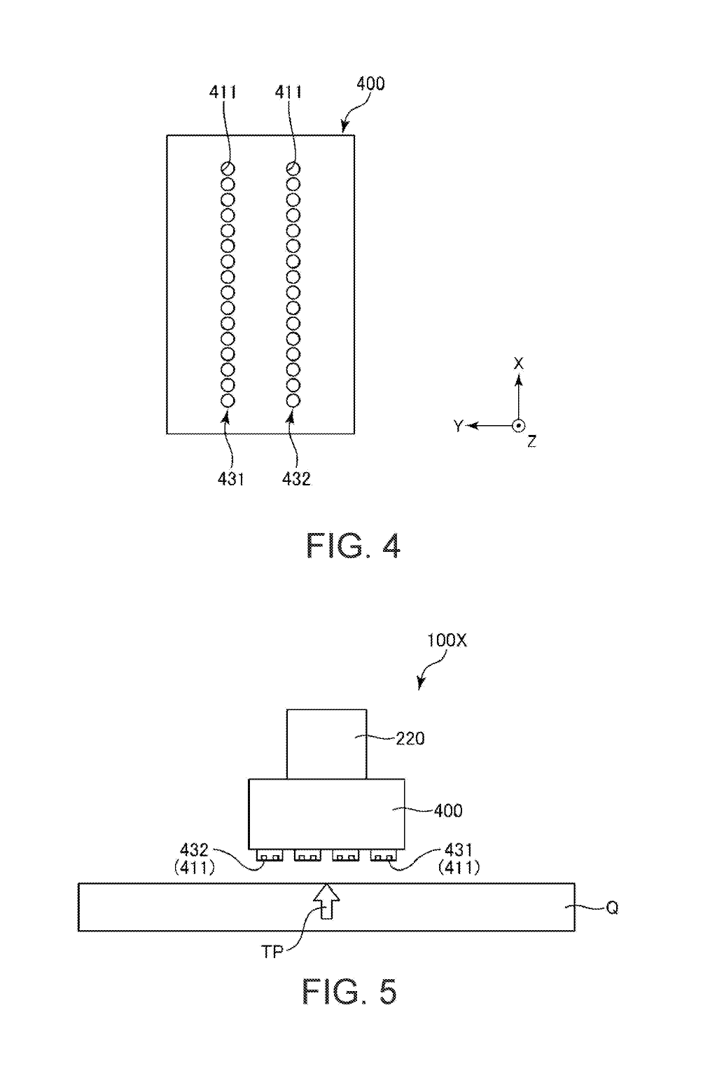

FIG. 4 is a partially enlarged view of the liquid ejection head 400 shown in FIG. 3. As shown in FIG. 4, the nozzles 411 constitute nozzle arrays arranged at equal intervals along an X axis. The liquid ejection head 400 illustrated in FIG. 4 includes, for example, a first nozzle array 431 and a second nozzle array 432. The first nozzle array 431 and the second nozzle array 432 are arranged along a Y axis at a predetermined interval. However, the configuration of the liquid ejection head 400 is not particularly limited. For example, the liquid ejection head 400 may have three or more nozzle arrays. In the first nozzle array 431 and the second nozzle array 432 shown in FIG. 4, the positions of the nozzles 411 in the X axis direction correspond to each other (the positions in the X axis direction are aligned), but may be shifted from each other. For example, the nozzles 411 constituting the second nozzle array 432 may be arranged corresponding to intermediate positions between the nozzles 411 constituting the first nozzle array 431.

The ink (liquid) ejected from the first nozzle array 431 and the ink (liquid) ejected from the second nozzle array 432 may be the same type of ink or may be different types of ink. The “same type” means that components contained therein, for example, components such as coloring materials such as pigments and dyes, and powders such as metal powders, ceramic powders, and resin powders are the same as each other. The “different types” mean that these components are different from each other.

The printing device 100 further includes a print controller 420. As shown in FIG. 2, the liquid ejection head 400 is connected to a print controller 420. In the example of FIG. 1, the print controller 420 is attached to the distal end of the arm 226 via the linear stage 300, similarly to the liquid ejection head 400. The print controller 420 controls the operation of the liquid ejection head 400 based on a control signal output from the control device 900.

The print controller 420 includes, for example, one or more processors such as a central processing unit (CPU), memory, and an external interface. Note that the print controller 420 may include a programmable logic device such as a field programmable gate array (FPGA) instead of the CPU or in addition to the CPU. The print controller 420 may be incorporated in the control device 900.

As shown in FIG. 3, the linear stage 300 includes a base section 310 connected to the arm 226, a stage 320 that moves with respect to the base section 310, and a movement mechanism 330 that moves the stage 320 with respect to the base section 310. As shown in FIG. 3, when three axes orthogonal to each other are defined as the X axis, the Y axis, and a Z axis, the stage 320 is movable in a direction along the Y axis with respect to the base section 310. The stage 320 is linearly guided in the Y axis direction by a linear guide (not shown), and can move smoothly. The liquid ejection head 400 is attached to a stage 320. Although small and lightweight, such a linear stage 300 can move the liquid ejection head 400 relative to the target object Q with high accuracy, independently of the operation of the robot arm 220. Therefore, even when the relative position of the liquid ejection head 400 with respect to the robot arm 220 is changed as in the present embodiment, the operation of the robot arm 220 is less likely to be affected.

The movement mechanism 330 moves the stage 320 in a direction along the Y axis with respect to the base section 310. The movement mechanism 330 includes a piezoelectric actuator 340 as a drive source. The piezoelectric actuator 340 vibrates by using expansion and contraction of a piezoelectric element and moves the stage 320 by transmitting the vibration to the stage 320. By this, it possible to further reduce the size and weight of the linear stage 300. The driving accuracy of the linear stage 300 is improved. Furthermore, since the piezoelectric actuator 340 has a large holding torque at the time of stopping, it has the advantages of there being no need to add a brake and high positional stability of the stage 320 at the time of stopping. Note that as the drive source, a mechanism other than the piezoelectric actuator 340, for example, a mechanism in which a rack and pinion gear and a rotary motor are combined, a mechanism in which a ball screw and a rotary motor are combined, or the like may be used.

The printing device 100 further includes a robot controller 240. The motors M and the encoders E are connected to the robot controller 240. The robot controller 240 controls the operation of the robot 200 based on a control signal output from the control device 900.

The robot controller 240 includes, as functional sections, an arm control section 242, a linear stage controller 244, and a storage section 246.

The arm control section 242 controls the robot arm 220 to a target posture by outputting a control signal for controlling the operation of the arm drive mechanism 230.

By outputting a control signal for controlling the operation of the linear stage 300, the linear stage controller 244 moves the liquid ejection head 400 to a target position with respect to the robot arm 220. As a result, the liquid ejection head 400 is moved relative to the target object Q fixed to the fixing member 700. Note that the linear stage controller 244 may be independent of the robot controller 240.

The storage section 246 stores a program necessary for the operation of the robot controller 240, data necessary for the execution of the program, and the like.

The robot controller 240 includes, for example, one or more processors such as CPUs, memory, an external interface, and the like. Note that the robot controller 240 may include a programmable logic device such as an FPGA instead of the CPU or in addition to the CPU.

The control device 900 controls the operations of the robot controller 240 and the print controller 420 to execute printing on the target object Q. The control device 900 includes a print control section 910 and a storage section 930 as functional sections. The print control section 910 includes a print data generation section 912 and a movement amount setting section 914.

The print data generation section 912 generates print data and outputs the print data to the robot controller 240 and the print controller 420.

The movement amount setting section 914 sets a relative movement amount of the liquid ejection head 400 by the linear stage 300 based on print data, specification information of the liquid ejection head 400, and the like. The set movement amount is output to the linear stage controller 244.

The storage section 930 stores a program necessary for the operation of the control device 900, data necessary for the execution of the program, and the like.

The control device 900 is formed of, for example, a computer, and includes a processor (CPU) that processes information, memory that is communicably connected to the processor, and an external interface. Various programs that can be executed by the processor are stored in the memory, and the processor realizes the above-described functions by reading and executing the various programs and the like stored in the memory.

### 1.2. Printing method

### 1.2.1. Problem to be solved by the present embodiment

First, prior to the description of a printing method according to the first embodiment, a problem to be solved by the printing method will be described.

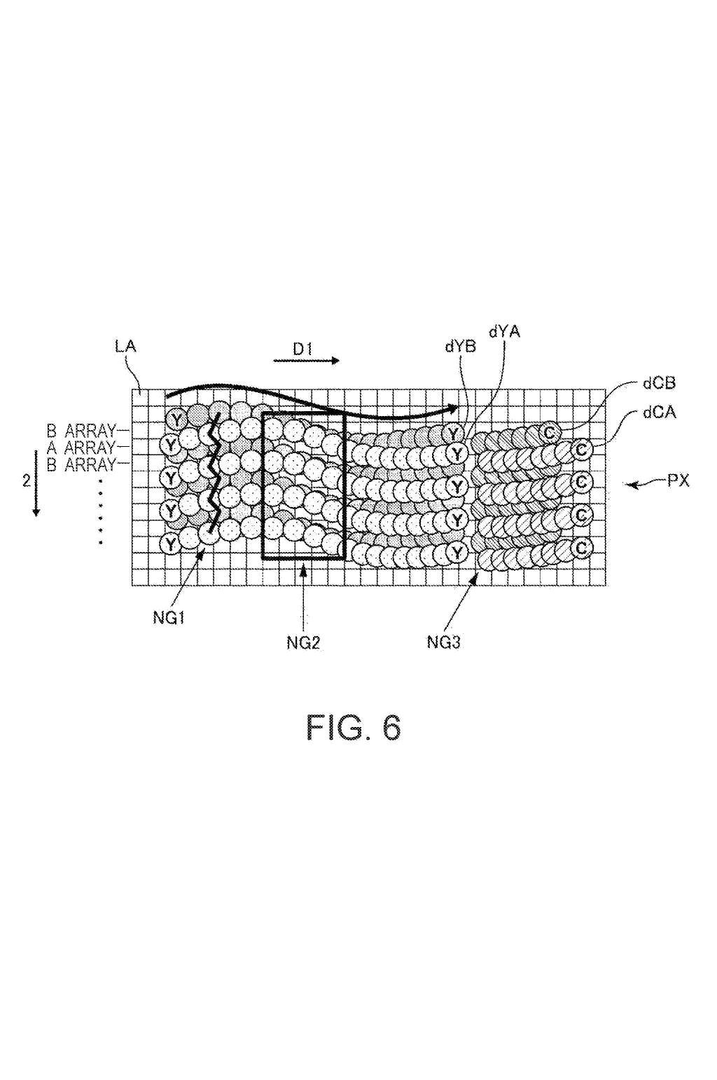

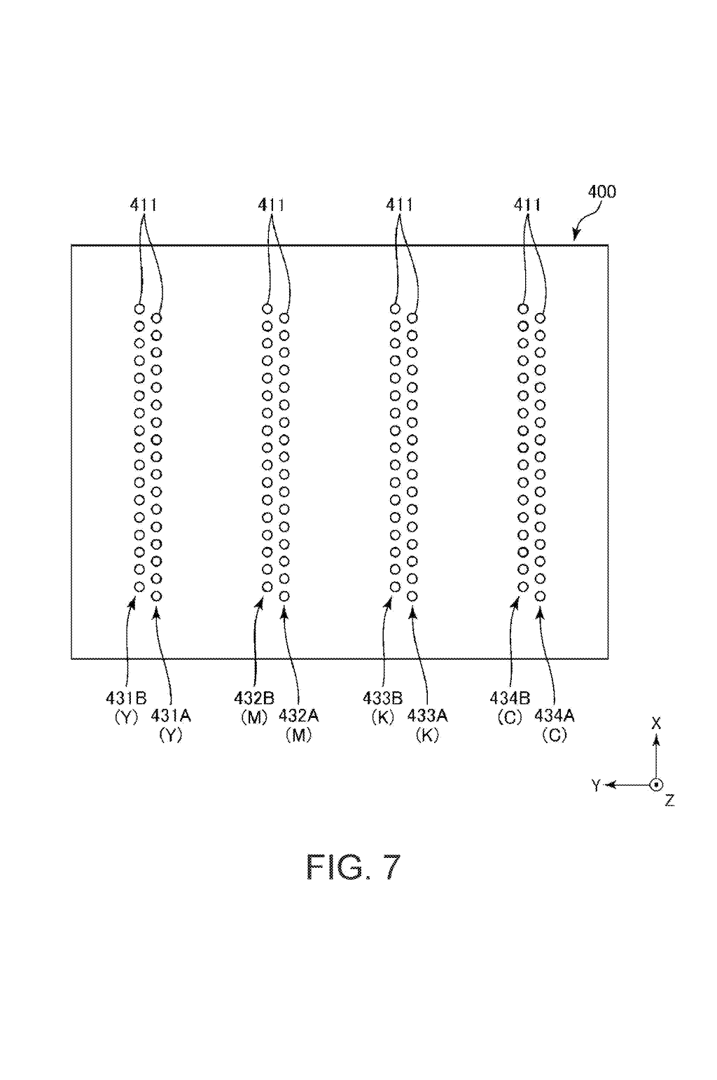

FIG. 5 is a side view schematically showing a part of a printing device 100X as related art for explaining a problem to be solved by the printing method according to the first embodiment. FIG. 6 is a plan view showing an example of a print pattern PX created using the printing device 100X shown in FIG. 5. FIG. 7 is a plan view showing the arrangement of the nozzles 411 of the liquid ejection head 400 used to form the print pattern PX shown in FIG. 6.

The printing device 100X illustrated in FIG. 5 includes a robot arm 220 and a liquid ejection head 400. The printing device 100X is the same as the printing device 100 described above except that the linear stage 300 is omitted. Note that FIG. 5 illustrates the liquid ejection head 400 in which eight nozzle arrays are arranged in the Y axis direction. In FIG. 5, two of the eight nozzle arrays are a first nozzle array 431 and a second nozzle array 432.

The linear stage 300 included in the robot system (printing device 100) according to the first embodiment described above has a function of moving the liquid ejection head 400 to a target position with respect to the robot arm 220. In contrast, the printing device 100X shown in FIG. 5 is not provided with the linear stage 300. For this reason, even though a first printing, in which ink is ejected from the first nozzle array 431 shown in FIG. 5, and a second printing, in which ink is ejected from the second nozzle array 432, are performed aiming at the same target position, print defects such as positional deviation of dots, color unevenness, and color deviation occur. In the present specification, “dot” is a point-like ink mark formed when ink discharged from a nozzle 411 lands on the target object Q. It is conceivable that such print defects are occur due to the following two causes (a) and (b).
(a) Oscillation is generated at the liquid ejection head 400 due to vibration of the robot arm 220.
(b) The oscillation phase of the liquid ejection head 400 during the first printing and the oscillation phase of the liquid ejection head 400 during the second printing differ from each other, due to the posture of the robot arm 220 when the first printing is performed at the target position and the posture of the robot arm 220 when the second printing is performed at the target position being different from each other.

The cause (a) is the cause of undulation in print pattern PX as shown in FIG. 6. The printing pattern PX is a printing result constituted by an aggregate of dots. “Undulation” refers to a state in which the print pattern PX, which is supposed to have a band shape (rectangular shape), vibrates with a predetermined distance cycle.

FIG. 6 illustrates grid-like reference lines drawn on the printing surface of the target object Q and the printing pattern PX printed over the reference lines. The reference lines shown in FIG. 6 include straight lines extending in parallel to a scanning direction D1 and arranged at equal intervals in a line feed direction D2, and straight lines extending in parallel to the line feed direction D2 and arranged at equal intervals in the scanning direction D1. Square lattices LA are formed inside the reference lines. The lattices LA represent positions where dots are supposed to be arranged when there is no undulation.

Rows of lattices LA extending in the scanning direction D1 and arranged in the line feed direction D2, are set as an A array or a B array. In FIG. 6, a plurality of arrays A and a plurality of arrays B are arranged alternately in the line feed direction D2.

The dots constituting the print pattern PX shown in FIG. 6 are divided into four types of dots dYA, dYB, dCA, and dCB for convenience of description. The dots dYA are yellow (Y) dots that are supposed to be arranged in an A array, the dots dYB are yellow (Y) dots that are supposed to be arranged in a B array, the dots dCA are cyan (C) dots that are supposed to be arranged in an A array, and the dot dCB are cyan (C) dots that are supposed to be arranged in a B array. A predetermined number of the dots dYA, dYB, dCA, and dCB are arranged along the scanning direction D1 to form dot arrays.

Such a print pattern PX is formed by ink ejected from the liquid ejection head 400 shown in FIG. 7.

The liquid ejection head 400 shown in FIG. 7 is an example in which the number of nozzle arrays, the arrangement of the nozzles 411, and the like are different from those of the liquid ejection head 400 shown in FIG. 3.

The liquid ejection head 400 illustrated in FIG. 7 includes a nozzle array 431A, a nozzle array 431B, a nozzle array 432A, a nozzle array 432B, a nozzle array 433A, a nozzle array 433B, a nozzle array 434A, and a nozzle array 434B. The nozzle array 431A and the nozzle array 431B have the same number of nozzles 411, but their positions in the X axis direction are shifted by half the pitch of the nozzles 411. The same applies to the nozzle array 432A and the nozzle array 432B, to the nozzle array 433A and the nozzle array 433B, and to the nozzle array 434A and the nozzle array 434B.

Yellow (Y) ink is ejected from the nozzle array 431A and the nozzle array 431B, magenta (M) ink is ejected from the nozzle array 432A and the nozzle array 432B, black (K) ink is ejected from the nozzle array 433A and the nozzle array 433B, and cyan (C) ink is ejected from the nozzle array 434A and the nozzle array 434B.

The number of nozzle arrays included in the liquid ejection head 400 is not particularly limited, and may be 3 to 7 or 9 or more.

The print pattern PX shown in FIG. 6 described above is formed by scanning the liquid ejection head 400 four times as follows.

In the first scan, the yellow ink is ejected from the nozzle array 431B to form the dots dYB.

In the second scan, the yellow ink is ejected from the nozzle array 431A to form the dots dYA.

In the third scan, the cyan ink is ejected from the nozzle array 434B to form the dots dCB.

In the fourth scan, the cyan ink is ejected from the nozzle array 434A to form the dots dCA.

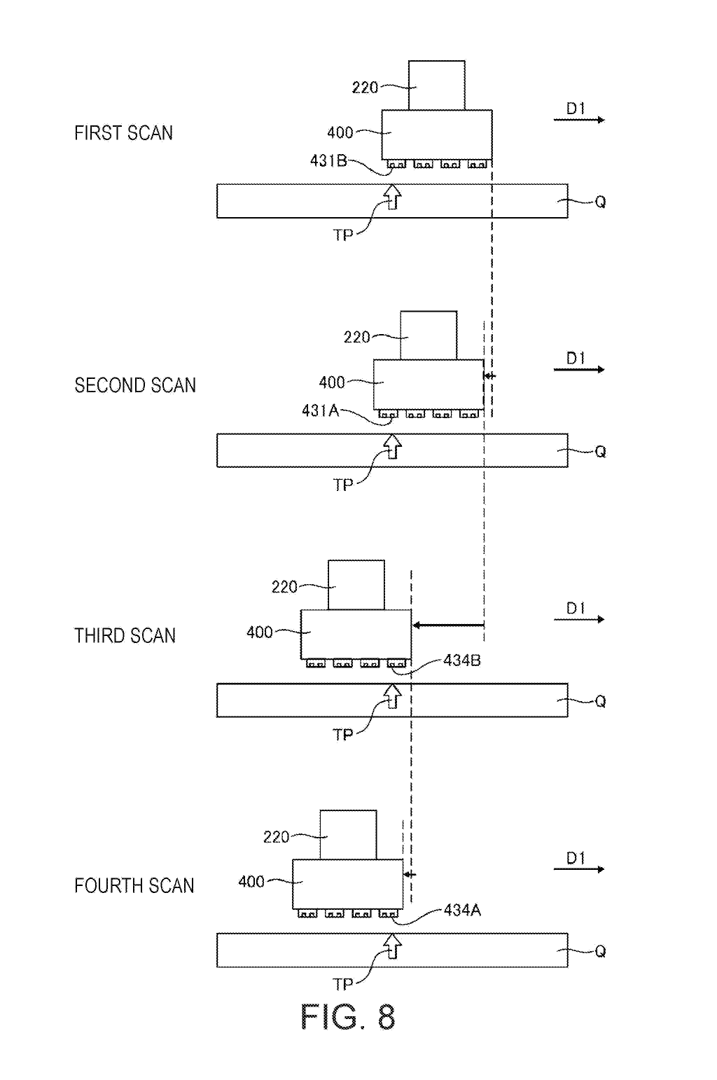

FIG. 8 is a diagram schematically showing positions of the liquid ejection head 400 and positions of the robot arm 220 at the moments when the dots dYB, dYA, dCB, and dCA are sequentially formed with respect to the target position TP in the first to fourth scans of the target object Q in the process of forming the print pattern PX shown in FIG. 6.

As shown in FIG. 8, the position of the liquid ejection head 400 and the position of the robot arm 220 are different when the dots dYB, dYA, dCB, and dCA are formed with respect to the target position TP. That is, in FIG. 8, from the first scan to the fourth scan, the distal end position of the robot arm 220 is gradually shifted with respect to the target object Q fixed by the fixing member 700. Therefore, in each of the first to fourth scans, the posture of the robot arm 220 is also different, and the oscillation phase of the liquid ejection head 400 is also different.

It is understood that as illustrated in FIG. 6, such a difference in the oscillation phase causes the oscillation phase of the dot array formed by the dots dYB and the oscillation phase of the dot array formed by the dots dYA to be different from each other. Therefore, the above-described cause (b) can be explained with reference to FIG. 8.

The above-described causes (a) and (b) cause a deviation in dot arrangement for each scan, which leads to various print defects.

For example, positional deviation of dots indicated in FIG. 6 as print defect NG1 occurs or color unevenness indicated in FIG. 6 as print defect NG2 occurs. Positional deviation of dots causes monochromatic deviation in an image formed with a density difference of a single color, leading to a decrease in image quality. “Color unevenness” refers to a state in which a recognizable unevenness occurs in the density of a color, as a result of the occurrence of a portion where the base material can be greatly seen due to an increase in the deviation of the overlap width between dots.

A print defect NG3 in FIG. 6 is a defect in which the connection between a pattern constituted by dots dYB and dYA and a pattern constituted by the dots dCB and dCA is shifted. Such a defect is also referred to as color shift.

### 1.2.2. Configuration of printing method according to present embodiment

In consideration of the above-described problem, the present inventors conducted intensive studies on means for suppressing the occurrence of print defects even when the liquid ejection head 400 oscillates. They found that by adjusting the position of the liquid ejection head 400 according to the position of the nozzle 411 at the timing at which the ink is ejected from the nozzle 411, it is possible to suppress the deviation in oscillation phase and to suppress the occurrence of print defects, and achieved completion of the disclosure.

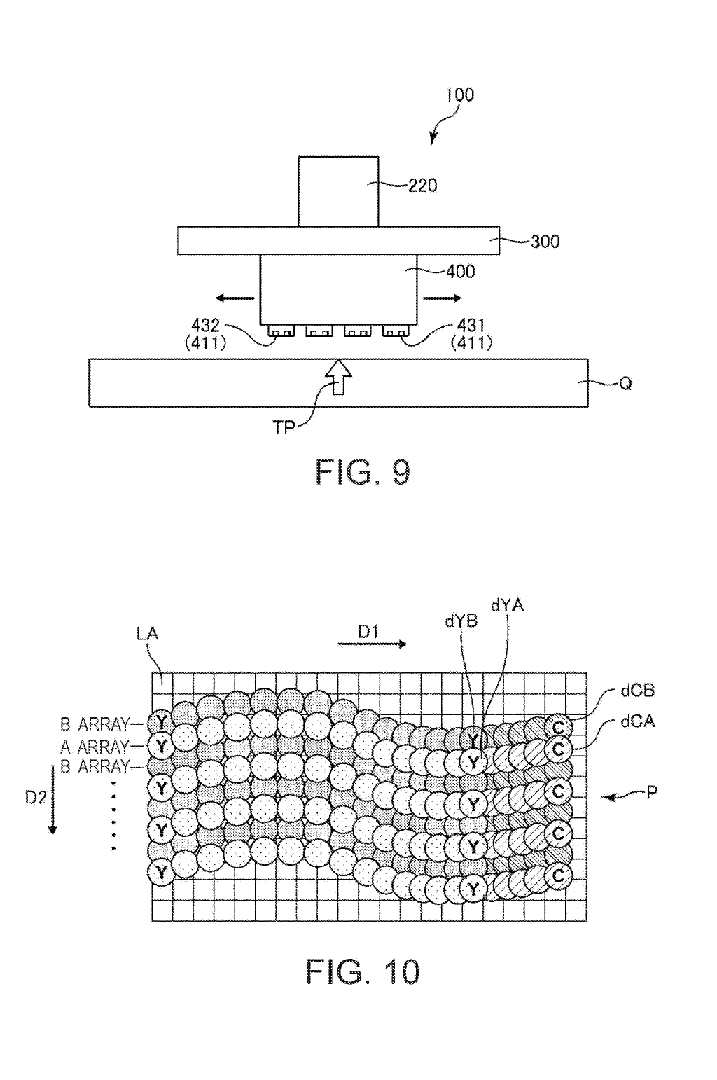

FIG. 9 is a side view schematically showing a part of the printing device 100 shown in FIG. 1. FIG. 10 is a plan view showing an example of a printing pattern P created using the printing device 100 shown in FIG. 9.

As described above, the printing device 100 illustrated in FIG. 9 includes the robot arm 220, the linear stage 300, and the liquid ejection head 400. The linear stage 300 shown in FIG. 9 moves the liquid ejection head 400 to a target position with respect to the robot arm 220. That is, as a result, the liquid ejection head 400 is moved relative to the target object Q, which is fixed by the fixing member 700. By this, the printing pattern P shown in FIG. 10 becomes a pattern having the same undulation as that of FIG. 6, but the occurrence of the print defects NG1 to NG3 is suppressed.

Hereinafter, each step of the printing method according to the first embodiment will be described. Note that in the following description, a printing method using the above-described printing device 100 will be described as an example.

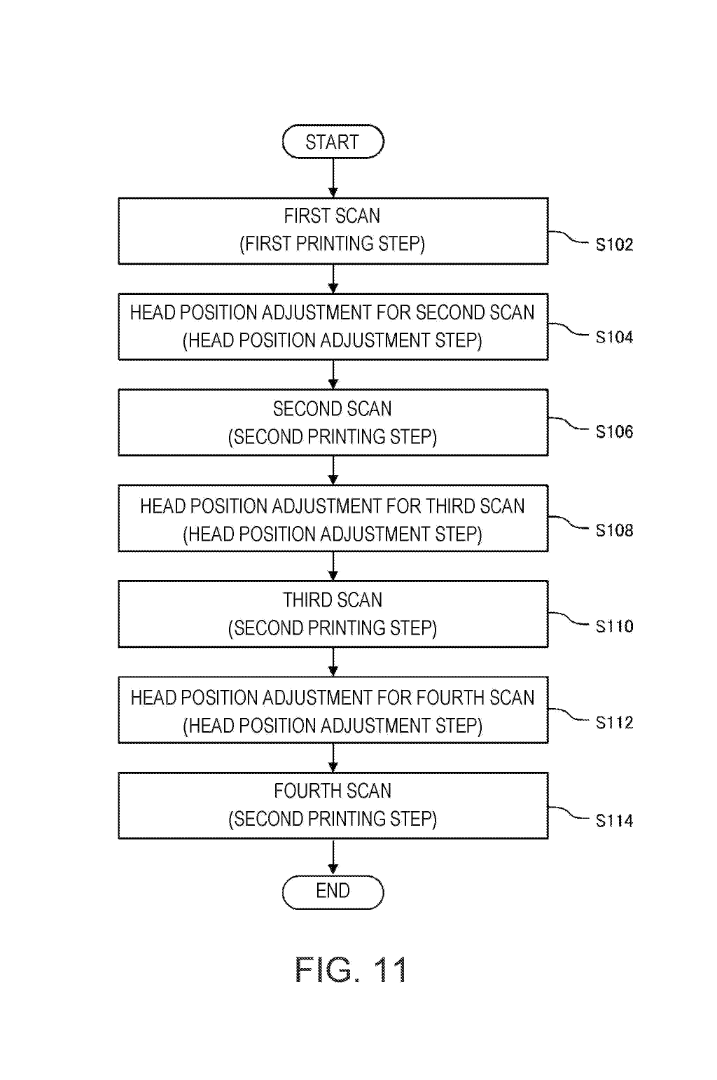

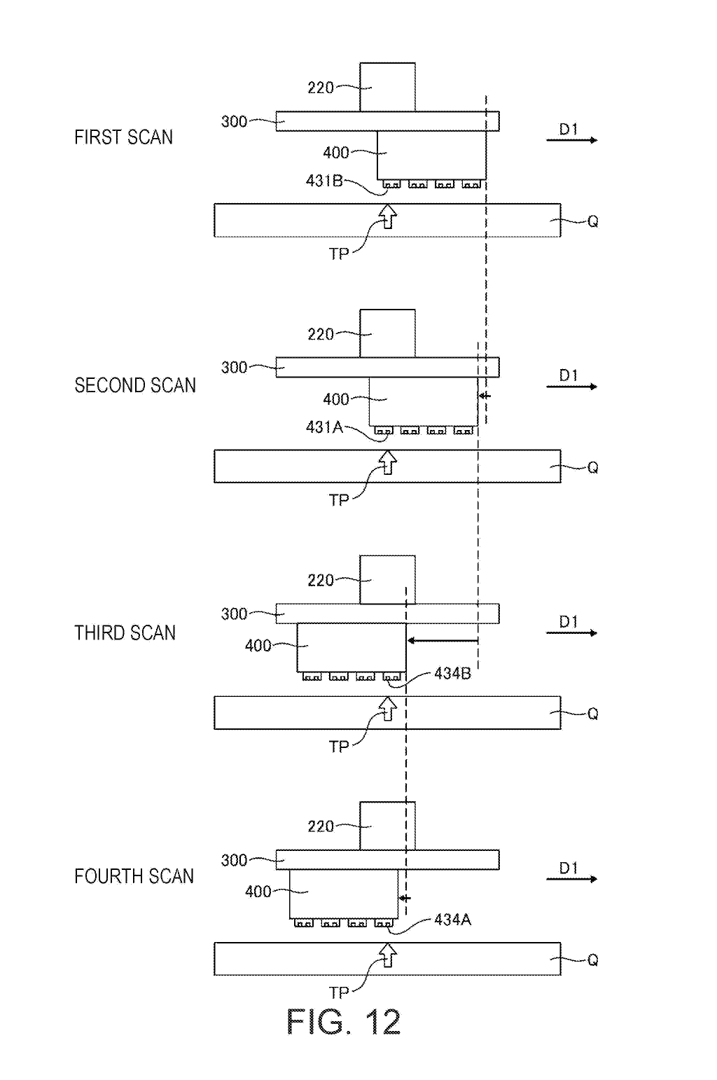

FIG. 11 is a flowchart for explaining the printing method according to the first embodiment. FIG. 12 is a diagram schematically showing the position of the liquid ejection head 400 and the position of the robot arm 220 at the moments when the dots dYB, dYA, dCB, and dCA are sequentially formed in the first to fourth scans with respect to the target position TP of the target object Q in the process of forming the printing pattern P shown in FIG. 10.

The printing method shown in FIG. 11 includes a first scan S102 (first printing step), a head position adjustment S104 for a second scan (head position adjustment step), the second scan S106 (second printing step), a head position adjustment S108 for a third scan (head position adjustment step), the third scan S110 (second printing step), a head position adjustment S112 for a fourth scan (head position adjustment step), and the fourth scan S114 (second printing step).

### 1.2.2.1. First scan. First printing step

In the first scan S102, the first scan of the liquid ejection head 400 is performed, and the first printing is performed on the target object Q. In the first scan S102, the yellow ink is ejected from the nozzle array 431B. At this time, when viewed at the moment when the dots dYB are formed with respect to the target position TP of the target object Q shown in FIG. 12, the nozzle array 431B is positioned directly above the target position TP. At this moment, the relative position of the distal end with respect to the proximal end of the robot arm 220 is the predetermined position shown in FIG. 12. Note that for convenience of illustration, the proximal end of the robot arm 220 is not shown in FIG. 12. The control device 900 stores this predetermined position.

From this state, while performing the first scan in which the liquid ejection head 400 is scanned along a predetermined scan trajectory, the yellow ink is ejected from the nozzle array 431B, thereby performing the first printing in which the dot array formed of the dots dYB is formed on the target object Q.

### 1.2.2.2. Head position adjustment for second scan. Head position adjustment step

In the head position adjustment S104 for the second scan, the linear stage 300 is operated to adjust the position of the liquid ejection head 400. To be specific, the linear stage 300 is operated to move the liquid ejection head 400 so that the nozzle array 431A is arranged directly above the target position TP shown in FIG. 12 and so that the relative position of the distal end with respect to the proximal end of the robot arm 220 becomes the predetermined position stored in the first scan S102. That is, as viewed from the target object Q, the linear stage 300 moves the liquid ejection head 400 relative to the target object Q. By this, in the present embodiment, the positional relationship between the liquid ejection head 400 and the robot arm 220 can be changed from positional relationship at the time of the first printing. To be specific, in a state where the nozzle array 431A is disposed at the same position as the nozzle array 431B at the time of the first printing, the position of the distal end of the robot arm 220 in the base coordinate system is set to be the same as that at the time of the first printing. As a result, even though the nozzle array 431B, which is different from the nozzle array 431A used in the first printing, is disposed directly above the target position TP, it is possible to set the posture of the robot arm 220 to the same posture as in the first printing.

### 1.2.2.3. Second scan. Second printing step

In the second scan S106, the second scan of the liquid ejection head 400 is performed, and the second printing is performed on the target object Q. In the second scan S106, the yellow ink is ejected from the nozzle array 431A. At this time, when viewed at the moment when the dots dYA are formed with respect to the target position TP of the target object Q shown in FIG. 12, the nozzle array 431A is positioned directly above the target position TP. At this moment, the relative position of the distal end with respect to the proximal end of the robot arm 220 is the same as that in the first scan.

From this state, while performing the second scan in which the liquid ejection head 400 is scanned along the same scan trajectory as that of the first printing, the yellow ink is ejected from the nozzle array 431A, thereby performing the second printing in which the dot array formed of the dots dYA is formed on the target object Q.

By doing this, the posture of the robot arm 220 at the time of performing the first printing and the posture of the robot arm 220 at the time of performing the second printing can be the same. That is, during the first scan and during the second scan, the postures of the robot arm 220 are aligned with each other. Therefore, the oscillation phase of the liquid ejection head 400 during the first printing and the oscillation phase of the liquid ejection head 400 during the second printing can be aligned with each other. As a result, it is possible to suppress the occurrence of the print defects NG1 and NG2 described above.

### 1.2.2.4. Head position adjustment for third scan. Head position adjustment step

In head position adjustment S108 for the third scan, the linear stage 300 is operated to adjust the position of the liquid ejection head 400. To be specific, the linear stage 300 is operated to move the liquid ejection head 400 so that the nozzle array 434B is arranged directly above the target position TP shown in FIG. 12 and so that the relative position of the distal end with respect to the proximal end of the robot arm 220 becomes the predetermined position stored in the first scan S102. As a result, even though the nozzle array 431B, which is different from the nozzle array 434B used in the first printing, is disposed directly above the target position TP, it is possible to set the posture of the robot arm 220 to the same posture as in the first printing.

### 1.2.2.5. Third scan. Second printing step

In the third scan S110, the third scan of the liquid ejection head 400 is performed, and the third printing is performed on the target object Q. In the third scan S110, the cyan ink is ejected from the nozzle array 434B. At this time, when viewed at the moment when the dots dCB are formed with respect to the target position TP of the target object Q shown in FIG. 12, the nozzle array 434B is positioned directly above the target position TP. At this moment, the relative position of the distal end with respect to the proximal end of the robot arm 220 is the same as that in the first scan.

From this state, while performing the third scan in which the liquid ejection head 400 is scanned along the same scan trajectory as that in the first printing, the cyan ink is ejected from the nozzle array 434B, thereby performing the third printing in which the dot array formed of the dots dCB is formed on the target object Q.

By doing this, the posture of the robot arm 220 at the time of performing the first printing and the posture of the robot arm 220 at the time of performing the third printing can be the same. Therefore, the oscillation phase of the liquid ejection head 400 during the first printing and the oscillation phase of the liquid ejection head 400 during the third printing can be aligned with each other. As a result, it is possible to suppress the occurrence of the print defect NG3 described above.

### 1.2.2.6. Head position adjustment for fourth scan. Head position adjustment step

In head position adjustment S112 for the fourth scan, the linear stage 300 is operated to adjust the position of the liquid ejection head 400. To be specific, the linear stage 300 is operated to move the liquid ejection head 400 so that the nozzle array 434A is arranged directly above the target position TP shown in FIG. 12 and so that the relative position of the distal end with respect to the proximal end of the robot arm 220 becomes the predetermined position stored in the first scan S102. As a result, even though the nozzle array 434B different from that in the first printing is disposed directly above the target position TP, it is possible to set the posture of the robot arm 220 to the same posture as that in the first printing.

### 1.2.2.7. Fourth scan. Second printing step

In the fourth scan S114, the fourth scan of the liquid ejection head 400 is performed, and the fourth printing is performed on the target object Q. In the fourth scan S114, the cyan ink is ejected from the nozzle array 434A. At this time, when viewed at the moment when the dots dCA are formed with respect to the target position TP of the target object Q shown in FIG. 12, the nozzle array 434A is positioned directly above the target position TP. At this moment, the relative position of the distal end with respect to the proximal end of the robot arm 220 is the same as that in the first scan.

From this state, while performing the fourth scan in which the liquid ejection head 400 is scanned along the same scan trajectory as that in the first printing, the cyan ink is ejected from the nozzle array 434A, thereby performing the fourth printing in which the dot array formed of the dots dCA is formed on the target object Q.

By doing this, the posture of the robot arm 220 at the time of performing the first printing and the posture of the robot arm 220 at the time of performing the fourth printing can be the same. Therefore, the oscillation phase of the liquid ejection head 400 during the first printing and the oscillation phase of the liquid ejection head 400 during the fourth printing can be aligned with each other. As a result, it is possible to suppress the occurrence of the print defect NG3 described above.

As described above, even in a case where the liquid ejection head 400 performs the printing operation while oscillating, it is possible to suppress the occurrence of the print defects NG1 to NG3 by appropriately operating the linear stage 300.

### 2. SECOND EMBODIMENT

Next, a printing method and a robot system according to a second embodiment will be described.

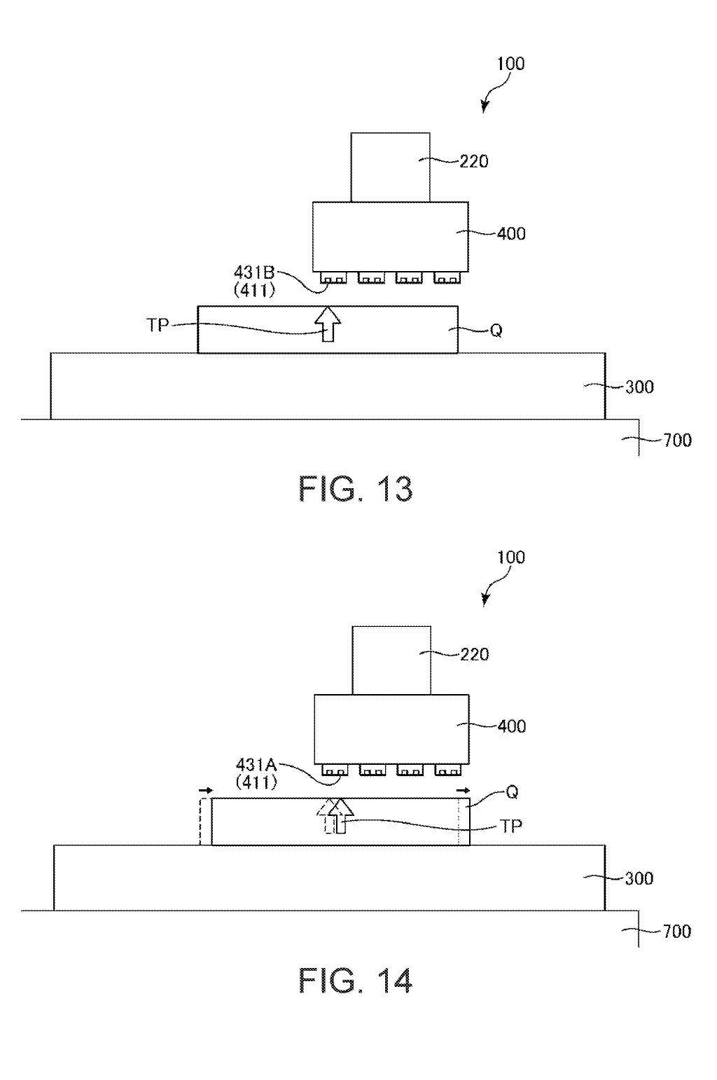

FIGS. 13 and 14 are side views schematically showing a part of a printing device used in the printing method according to the second embodiment.

Hereinafter, a second embodiment will be described, but in the following description, differences from the first embodiment will be mainly described, and a description of similar matters will be omitted. Note that in FIGS. 13 and 14, the same components as those of the first embodiment are denoted by the same reference numerals.

The printing method according to the second embodiment is the same as the printing method according to the first embodiment except that the linear stage 300 is disposed at a position separated from the robot arm 220.

In the first embodiment described above, the linear stage 300 is connected to the robot arm 220. On the other hand, in the present embodiment, the linear stage 300 is fixed to the fixing member 700. The target object Q is held on the linear stage 300. That is, the linear stage 300 is disposed between the target object Q and the fixing member 700.

In the printing method according to the second embodiment, the same effects as those of the printing method according to the first embodiment are obtained.

Hereinafter, each step of the printing method according to the second embodiment will be described. Note that in the following description, a printing method using the printing device 100 shown in FIGS. 13 and 14 will be described as an example, but the printing device used in the printing method is not limited thereto.

### 2.1. First scan. First printing step

In the first scan S102, the nozzle array 431B is positioned directly above the target position TP. At this moment, the relative position of the distal end of the robot arm 220 is at a predetermined position shown in FIG. 13.

From this state, while performing the first scan in which the liquid ejection head 400 is scanned along a predetermined scan trajectory, the yellow ink is ejected from the nozzle array 431B, thereby performing the first printing in which the dot array formed of the dots dYB is formed on the target object Q.

### 2.2. Head position adjustment for second scan. Head position adjustment step

In the head position adjustment S104 for the second scan, the linear stage 300 is operated and the target object Q is moved with respect to the liquid ejection head 400. Said differently, the linear stage 300 moves the liquid ejection head 400 relative to the target object Q. As a result, even though the nozzle array 431B, which is different from the nozzle array 431A used in the first printing, is arranged directly above the target position TP, the distal end position of the robot arm 220 with respect to the fixing member 700 has not changed. Therefore, it is possible to set the posture of the robot arm 220 to the same posture as in the first printing.

### 2.3. Second scan. Second printing step

In the second scan S106, while performing the second scan in which the liquid ejection head 400 is scanned along the same scan trajectory as that of the first printing, the yellow ink is ejected from the nozzle array 431A, thereby performing the second printing in which the dot array formed of the dots dYA is formed on the target object Q.

By doing this, since the posture of the robot arm 220 at the time of performing the first printing and the posture of the robot arm 220 at the time of performing the second printing are the same, it is possible to align the oscillation phase of the liquid ejection head 400 at the time of the first printing and the oscillation phase of the liquid ejection head 400 at the time of the second printing. That is, the relative position of the distal end with respect to the proximal end of the robot arm 220 does not change between when the nozzle array 431B shown in FIG. 13 is disposed directly above the target position TP and when the nozzle array 431A shown in FIG. 14 is disposed directly above the target position TP. As a result, it is possible to suppress the occurrence of the print defects NG1 and NG2 described above.

Up to the second scan has been described but the third and fourth scans are similar to those in the first embodiment. Therefore, by performing the third and fourth scans, the occurrence of the print defect NG3 can also be suppressed.

As described above, even in a case where the liquid ejection head 400 performs the printing operation while oscillating, it is possible to suppress the occurrence of the print defects NG1 to NG3 by appropriately operating the linear stage 300.

In the second embodiment, the liquid ejection head 400 can be fixed to the robot arm 220. By this, since the center of gravity does not move at the distal end of the robot arm 220, it is possible to further suppress a change in vibration in the robot arm 220.

### 3. EFFECTS ACHIEVED BY THE EMBODIMENTS

As described above, the printing method according to each of the above-described embodiments is a method of performing printing on the target object Q using the liquid ejection head 400 and the robot 200, which includes the robot arm 220 and the linear stage 300, in which the liquid ejection head 400 ejects ink (liquid) while the robot arm 220 scans the liquid ejection head 400, and includes a first printing step, a head position adjustment step, and a second printing step. The liquid ejection head 400 includes the first nozzle array 431 and the second nozzle array 432, which are configured by a plurality of nozzles 411 that eject ink. Assuming that the direction in which the first nozzle array 431 and the second nozzle array 432 are arranged is defined as the scanning direction D1, the robot arm 220 causes the liquid ejection head 400 to scan the target object Q in the scanning direction D1. The linear stage 300 moves the liquid ejection head 400 relative to the target object Q.

In the first printing step, in a state where the relative position of the distal end with respect to the proximal end of the robot arm 220 is at a predetermined position, the first printing is performed on the target object Q by ejecting ink from the first nozzle array 431 while the robot arm 220 scans the liquid ejection head 400 relative to the target object Q.

In the head position adjustment step, after the first printing step, the linear stage 300 moves the liquid ejection head 400 relative to the target object Q so that the second nozzle array 432 is arranged at the same position as the first nozzle array 431 at the time of the first printing and so that the relative position of the distal end of the robot arm 220 becomes the predetermined position described above.

In the second printing step, after the head position adjustment step, the second printing is performed on the target object Q by ejecting the ink from the second nozzle array 432 while the robot arm 220 scans the liquid ejection head 400 relatively to the target object Q along the same scan trajectory as that in the first printing.

According to such a configuration, since the posture of the robot arm 220 at the time of performing the first printing and the posture of the robot arm 220 at the time of performing the second printing are the same, it is possible to align the oscillation phase of the liquid ejection head 400 at the time of the first printing and the oscillation phase of the liquid ejection head 400 at the time of the second printing. Therefore, even in a case where the liquid ejection head 400 having a plurality of nozzle arrays performs a printing operation while oscillating, it is possible to realize a printing method in which print defects are suppressed to a low level.

The linear stage 300 desirably includes the base section 310, the stage 320 that moves with respect to the base section 310, and the movement mechanism 330 that moves the stage 320 in the scanning direction D1 with respect to the base section 310.

According to such a configuration, because the linear stage 300 is small and lightweight, the operation of the robot arm 220 is less likely to be affected even when the relative position of the liquid ejection head 400 with respect to the robot arm 220 is changed using the linear stage 300.

The movement mechanism 330 desirably includes a piezoelectric actuator. By this, it possible to further reduce the size and weight of the linear stage 300. The driving accuracy of the linear stage 300 is improved. Furthermore, since the piezoelectric actuator 340 has a large holding torque at the time of stopping, it has the advantages of there being no need to add a brake and high positional stability of the stage 320 at the time of stopping.

In the printing device used for the printing method according to the first embodiment, the robot arm 220 is connected to the base section 310, and the liquid ejection head 400 is attached to the stage 320.

According to such a configuration, the linear stage 300 can move the liquid ejection head 400 to a target position with respect to the robot arm 220. Therefore, even in a state where the target object Q is fixed, it is possible to relatively move the liquid ejection head 400 with respect to the target object Q. Therefore, even in a state in which the target object Q is fixed, it is possible to obtain the above-described effect, that is, the effect that the posture of the robot arm 220 when the first printing is performed and the posture of the robot arm 220 when the second printing is performed can be the same.

In the printing device used for the printing method according to the second embodiment, the linear stage 300 is disposed separate from the robot arm 220, and the target object Q is held on the stage 320.

According to such a configuration, the liquid ejection head 400 can be fixed to the robot arm 220. By this, since the center of gravity does not move at the distal end of the robot arm 220, it is possible to further suppress a change in vibration in the robot arm 220.

The robot system (printing device 100) according to each of the embodiments includes the liquid ejection head 400, the robot 200, which includes the robot arm 220 and the linear stage 300, and the control device 900, which controls the operation of the robot 200. The liquid ejection head 400 includes the first nozzle array 431 and the second nozzle array 432, which are configured by a plurality of nozzles 411 that eject ink. Assuming that the direction in which the first nozzle array 431 and the second nozzle array 432 are arranged is defined as the scanning direction D1, the robot arm 220 causes the liquid ejection head 400 to scan the target object Q in the scanning direction D1. The linear stage 300 moves the liquid ejection head 400 relative to the target object Q. The control device 900 controls the operation of the robot 200.

The control device 900 performs the first printing operation, the head position adjustment operation, and the second printing operation.

In the first printing operation, from a state in which the relative position of the distal end with respect to the proximal end of the robot arm 220 is at a predetermined position, the first printing is performed on the target position TP of the target object Q by ejecting ink (liquid) from the first nozzle array 431 while causing the robot arm 220 to scan the liquid ejection head 400 relative to the target object Q.

In the head position adjustment operation, after the first printing operation, the linear stage 300 causes the liquid ejection head 400 relative to the target object Q such that the second nozzle array 432 is disposed at the same position as the first nozzle array 431 at the time of the first printing and such that the relative position of the distal end of the robot arm 220 becomes the above-described predetermined position.

In the second printing operation, after the head position adjustment operation, the second printing is performed on the target position TP of the target object Q by ejecting the ink from the second nozzle array 432 while causing the robot arm 220 to scan the liquid ejection head 400 relative to the target object Q along the same scan trajectory as in the first printing.

According to such a configuration, since the posture of the robot arm 220 at the time of performing the first printing and the posture of the robot arm 220 at the time of performing the second printing can be made the same, it is possible to align the oscillation phase of the liquid ejection head 400 at the time of the first printing and the oscillation phase of the liquid ejection head 400 at the time of the second printing. Therefore, it is possible to realize a printing device in which print defects are suppressed to a low level even in a case where the liquid ejection head 400 having a plurality of nozzle arrays is caused to perform a printing operation while oscillating.

Although the printing method and the robot system according to the disclosure have been described based on the embodiments shown in the drawings, the printing method and the robot system according to the disclosure are not limited to the embodiments. For example, the printing method according to the disclosure may be a method in which a step or an operation for an arbitrary purpose is added to the embodiment. In the robot system according to the disclosure, each section of the embodiments may be replaced with an arbitrary configuration having the same function, and arbitrary components may be added to the embodiment.

1. A printing method using
an ink ejection head including a first nozzle array and a second nozzle array, the first nozzle array and the second nozzle array each including a plurality of nozzles for ejecting ink and
a robot including
a robot arm that causes the ink ejection head to scan in a scanning direction with respect to a target object, assuming that a direction in which the first nozzle array and the second nozzle array are arranged is the scanning direction and
a linear stage that causes the ink ejection head to relatively move with respect to the target object,
the printing method being for printing on the target object by ejecting ink from the ink ejection head while the robot arm causes the ink ejection head to scan, the printing method comprising:
a first printing step of, in a state where a relative position of a distal end of the robot arm with respect to a proximal end of the robot arm is at a predetermined position, performing a first printing on the target object by ejecting ink from the first nozzle array while the robot arm causes the ink ejection head to scan relative to the target object;
a head position adjustment step of, after the first printing step, causing the linear stage to move the ink ejection head relative to the target object such that the second nozzle array is arranged at the same position as the first nozzle array at the time of the first printing and so that the relative position of the distal end of the robot arm becomes the predetermined position; and
a second printing step of, after the head position adjustment step, performing a second printing on the target object by ejecting ink from the second nozzle array while the robot arm relatively scans the ink ejection head with respect to the target object along the same scan trajectory as in the first printing.

2. The printing method according to claim 1, wherein
the linear stage includes
a base section,
a stage that moves relative to the base section, and
a movement mechanism configured to move the stage in the scanning direction with respect to the base section.

3. The printing method according to claim 2, wherein
the movement mechanism includes a piezoelectric actuator.

4. The printing method according to claim 2, wherein
the robotic arm is connected to the base section and
the ink ejection head is attached to the stage.

5. The printing method according to claim 2, wherein
the linear stage is disposed separate from the robotic arm and
the target object is held on the stage.

6. A robot system comprising:
an ink ejection head including a first nozzle array and a second nozzle array, the first nozzle array and the second nozzle array each including a plurality of nozzles for ejecting ink,
a robot including
a robot arm that causes the ink ejection head to scan in a scanning direction with respect to a target object, assuming that a direction in which the first nozzle array and the second nozzle array are arranged is the scanning direction and
a linear stage that causes the ink ejection head to relatively move with respect to the target object, and
a control device that controls an operation of the robot, wherein
the control device executes
a first printing operation of, from a state where a relative position of a distal end of the robot arm with respect to a proximal end of the robot arm is at a predetermined position, causing the robot arm to perform a first printing with respect to a target position of the target object by causing ink to be ejected from the first nozzle array while causing the ink ejection head to scan relatively to a target position of the target object;
a head position adjustment operation of, after the first printing operation, causing the linear stage to move the ejection head relative to target object so as to arrange the second nozzle array at the same position as the first nozzle array at the time of the first printing and so that the relative position of the distal end of the robot arm becomes the predetermined position; and
a second printing operation of, after the head position adjustment operation, performing a second printing on the target position of the target object by causing ink to be ejected from the second nozzle array while causing the robot arm to scan the ink ejection head relative to the target object along the same scan trajectory as in the first printing.
